(19) United States
(12) Patent Application Publication
(10) Pub. No.: US 2015/0286204 A1
(43) Pub. Date: Oct. 8, 2015

(54) PROGRAM-CREATION SUPPORTING DEVICE, METHOD, AND RECORDING MEDIUM

(71) Applicant: MITSUBISHI ELECTRIC CORPORATION, Tokyo (JP)

(72) Inventors: Takayuki Yamaoka, Tokyo (JP); Akihiro Inagaki, Aichi (JP); Kouki Oota, Aichi (JP)

(73) Assignee: Mitsubishi Electric Corporation, Tokyo (JP)

(21) Appl. No.: 14/440,098

(22) PCT Filed: Nov. 22, 2012
(86) PCT No.: PCT/JP2012/080301

§ 371 Date: May 1, 2015

(51) Int. Cl. G05B 19/05

(52) U.S. Cl. CPC G05B 19/056; G05B 2219/13004

(57) ABSTRACT

In order to support input of commands efficiently, a program-creation supporting device stores a first command and a second command that follows the first command in association with each other in a command database unit, stores a last command input from a user in a previous-command storage unit, searches for the first command in the command database unit by using a command stored in the command storage unit as a search key, in a waiting state for waiting for an input of a new command from the user to extract a second command corresponding to the command stored in the command storage unit, and displays the extracted second commands in a list format on a display screen.

### FIELD

The present invention relates to a program-creation supporting device that supports creation of a program for operating a programmable logic controller (PLC), a program-creation supporting method, and a recording medium having the program recorded therein.

### BACKGROUND

As one of programs for operating a PLC, there is a ladder program in which a control sequence of the PLC is defined in a ladder diagram format. The ladder diagram for showing a ladder program has two buses (a plus bus and a minus bus) that represent electric power symbolically. The two buses are arranged with a gap therebetween. A logic circuit configured by combining electric elements is arranged in a ladder shape between the two buses so as to connect the buses. The electric elements constituting the logic circuit are, for example, a relay, a coil, and the like. Each of electric elements respectively corresponds to a command. For creating such a ladder program, a program-creation supporting device is generally used. When a user sequentially inputs commands to the program-creation supporting device, the program-creation supporting device sequentially arranges the commands input from the user sequentially in the format of electric elements between the buses.

Patent Literature 1 discloses a technique that causes, when a user inputs a part of character strings, the candidates to be input corresponding to a part of the input character strings to be displayed to the user. When the user selects one character string from the displayed candidates to be input (hereinafter referred to just as “input candidates”), the character string that the user is about to input is complemented. According to this technique, the input candidates are calculated based on a part of the character strings currently input and a past input-history.

Patent Literature 2 discloses a technique that displays input candidates to a user, when the user inputs character strings in an input form. According to this technique, priority is set for each character string, and character strings are arranged and displayed as the input candidates in the order of the priority. The order of priority is automatically set according to the number of inputs of the character strings.

### CITATION LIST

### Patent Literatures

Patent Literature 1: Japanese Patent Application Laid-open No. 2007-299205

Patent Literature 2: Japanese Patent Application Laid-open No. 2011-187011

### SUMMARY

### Technical Problem

However, according to the technique disclosed in Patent Literature 1, there is a problem in that command candidates cannot be displayed if no character has been input. Therefore, the user has to consider a first character and input that character after conducting a research.

Furthermore, if the technique disclosed in Patent Literature 2 is applied to a program-creation supporting device, when the user inputs one command, one or more input candidates arranged in the order determined according to the number of inputs are displayed. That is, the display contents of the input candidates are created regardless of a recent input history. Therefore, it cannot be said that the technique disclosed in Patent Literature 2 is efficient as a function of supporting input of commands.

The present invention has been achieved in view of the above problems, and an object of the present invention is to provide a program-creation supporting device that can support input of commands efficiently, a program-creation supporting method, and a recording medium.

### Solution to Problem

In order to solve the aforementioned problems, a program-creation supporting device that creates a program for operating a programmable logic controller (PLC) based on commands sequentially input to the PLC from a user, the program-creation supporting device is constructed to include: a command database unit that is a database for storing a first command and a second command that follows the first command in association with each other; a command storage unit that stores therein a last command input from the user; a processing unit that searches for the first command in the command database unit by using a command stored in the command storage unit as a search key, in a waiting state for waiting an input of a new command from the user, and extracts a second command corresponding to the command stored in the command storage unit; and an output unit that displays the second commands extracted by the processing unit in a list format on a display screen.

### Advantageous Effects of Invention

The program-creation supporting device according to the present invention estimates commands to be input next based on the last command, the input of which is completed by a user, and displays the commands to the user. Accordingly, command input can be efficiently supported.

### BRIEF DESCRIPTION OF DRAWINGS

FIG. 1 shows a functional configuration of a program-creation supporting device according to an embodiment of the present invention.

FIG. 2 shows a hardware configuration example of the program-creation supporting device according to the embodiment of the present invention.

FIG. 3 is a flowchart for explaining an operation by which the program-creation supporting device establishes a personal database.

FIG. 4 is an explanatory diagram of a registration example in the personal database.

FIG. 5 is a flowchart for explaining an operation of the program-creation supporting device for calculating and displaying command candidates.

FIG. 6 shows an example of a list display screen.

### DESCRIPTION OF EMBODIMENTS

Exemplary embodiments of a program-creation supporting device, a program-creation supporting method, and a recording medium according to the present invention will be explained below in detail with reference to the accompanying drawings. The present invention is not limited to the embodiments.

### First Embodiment

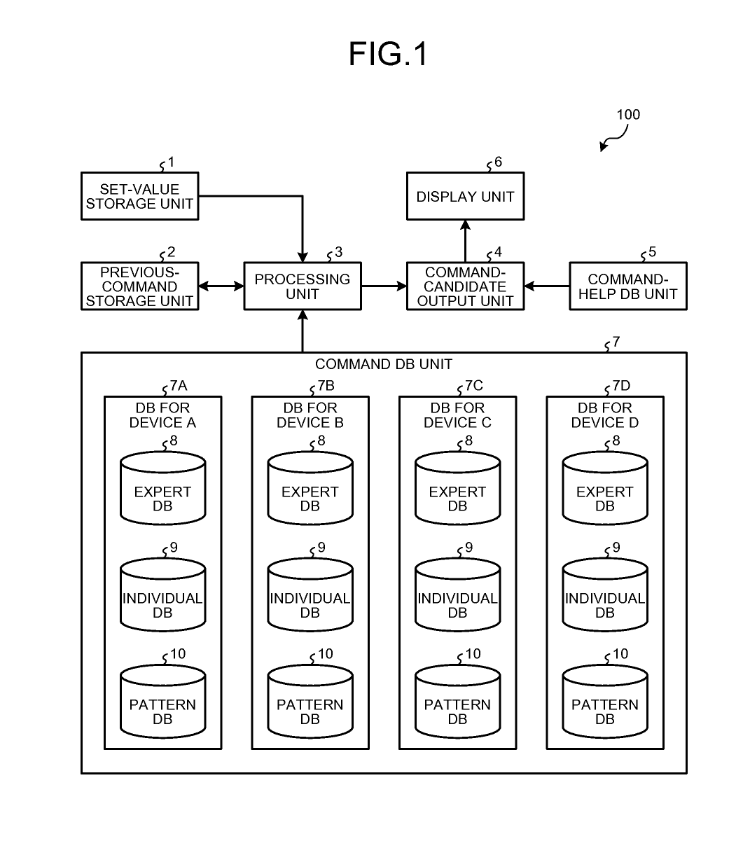

FIG. 1 shows a functional configuration of a program-creation supporting device according to an embodiment of the present invention. As shown in FIG. 1, a program-creation supporting device 100 includes a set-value storage unit 1, a previous-command storage unit 2, a processing unit 3, a command-candidate output unit 4, a command-help database (DB) unit 5, a display unit 6, and a command database (DB) unit 7.

The set-value storage unit 1 stores therein identification information that specifies an execution target device of a ladder program currently being edited. In the set-value storage unit 1, the identification information is set by a user, for example, when starting creation of the ladder program. As the type of device to be programmed, for example, a conveyance/transportation device, a machining device, and a data collecting/monitoring device can be mentioned. The set-value storage unit 1 transmits a stored value to the processing unit 3 in response to a request from the processing unit 3.

The previous-command storage unit 2 stores therein one or more commands lastly input by the user, during the time in which a ladder program is created by the user through operating the program-creation supporting device 100.

The database 7 is a database that stores therein a plurality of commands that can be continuously input as one set. Each set is registered in the command database unit 7 in a format in which the input order of commands configuring the set can be specified. That is, the command database unit 7 stores therein a first command and a second command that follows the first command in association with each other. The second command can be more than 1. For example, when two commands LDI and OUT are input as commands following the first command LD, the two commands LDI and OUT can be stored as the second command. Detailed configurations of the command database unit 7 are described later.

The processing unit 3 instructs the display unit 6 to display an edit screen, on which the ladder program currently being edited by the user is displayed, on an output device 104 described later. The user can sequentially input commands while watching the edit screen. The processing unit 3 sequentially writes the commands sequentially input from the user in the ladder program being edited, and outputs the completed ladder program to a storage device 102 described later (a ladder program 106).

After the completion of input of a new command by the user, the processing unit 3 calculates candidates for the next command (command candidates) of the new command. Specifically, the processing unit 3 receives the identification information from the set-value storage unit 1, and receives one or more commands lastly input from the previous-command storage unit 2. Further, the processing unit 3 searches the command database unit 7 by using the received information as a search key, and extracts the second command corresponding to one or more commands lastly input. The processing unit 3 designates the extracted second command as a command candidate.

The number of command candidates to be calculated can be plural. The processing unit 3 can set an upper limit to the number of command candidates to be calculated. As an example, it is assumed here that the set-value storage unit 1 stores therein a set value for specifying the number of command candidates beforehand, and the processing unit 3 calculates the command candidates by using the number set by the set value as an upper limit. Note that the method for selecting the command candidates is arbitrary, in a case in which the commands exceeding the upper limit are extracted from the command database unit 7. It is assumed here that the processing unit 3 records the number of commands used for each association of commands in the database unit 7, and the command which is used more frequently is preferentially set as the command candidate. The set value is set by the user in the set-value storage unit 1.

Furthermore, at the time of completion of input of a new command, the processing unit 3 associates the new command, the input of which is completed, with one or more commands stored in the previous-command storage unit 2, and registers the commands in the command database unit 7 (to be exact, in a personal database 9 described later). The processing unit 3 updates the command stored in the previous-command storage unit 2 in accordance with the completion of input of the new command.

The command-help database unit 5 stores therein a link to a storing position of a help related to the command beforehand for each command.

The command-candidate output unit 4 and the display unit 6 function as an output unit that displays the command candidates extracted by the processing unit 3 in a list format on a display screen in cooperation with each other.

The command-candidate output unit 4 searches the command-help database unit 5 by using the respective command candidates received from the processing unit 3 as a search key, and associates the obtained link with the command candidate that has been used as a search key. The command-candidate output unit 4 transmits the command candidate associated with the link to the display unit 6.

The display unit 6 generates an image frame of the edit screen on the basis of the command from the processing unit 3. The display unit 6 also generates a list display screen to display the command candidates received from the command-candidate output unit 4 in a list format. In the list display screen, pairs of the command candidate and the link associated with the command candidate are arranged.

The command database unit 7 is constituted by a plurality of types of database (an expert database 8, a personal database 9, and a pattern database 10) according to the method by which they are created.

The expert database 8 is a database in which a history of commands input by a specific expert is accumulated. Specifically, the expert database 8 stores therein a command input by an expert and one or more commands input by the expert immediately before the command in association with each other. The expert database 8 is created beforehand and is provided in the command database unit 7.

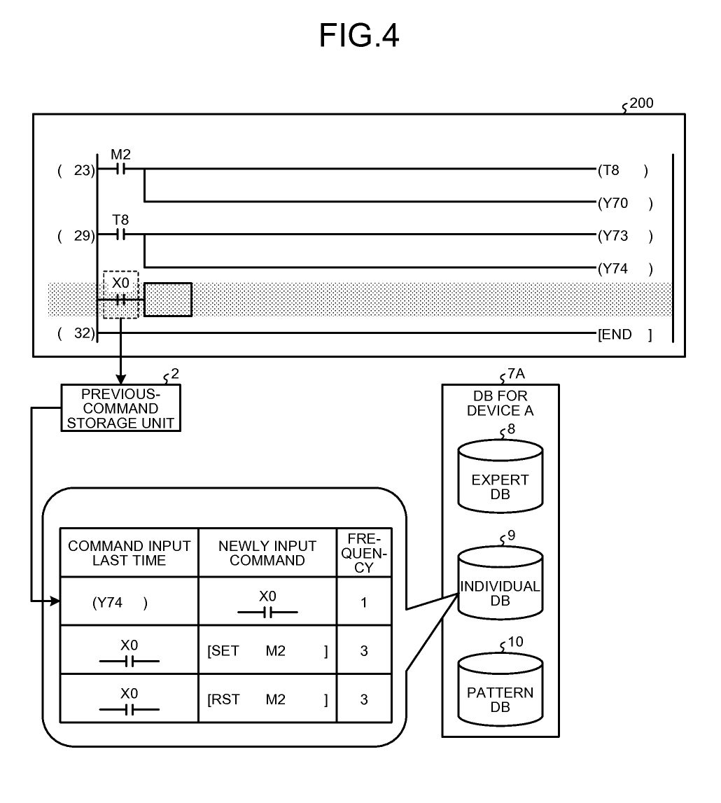

The personal database 9 is for accumulating an input history of commands by the user. The personal database 9 is configured by registering a first command and a second command in association with each other, designating a command input by the user as the second command and one or more commands input by the user immediately before the command as the first command. A specific realizing method of the association includes a method of preparing a table having columns such as “first command”, “second command”, and “frequency” and accumulating the input history therein by using a DB (database). As for an image of the database table, refer to the lower left table in FIG. 4. In the database, one row (in a lateral direction in FIG. 4) is regarded as being one candidate data. A registration operation is performed by the processing unit 3 as described above. The personal database 9 includes a field in which a count value is stored for each second command associated with the first command. The processing unit 3 does not provide an entry in which the same content as that of the already registered content (an entry in which the first command and the second command are paired) is to be registered as a new entry, but increments the count value related to the entry already registered.

The pattern database 10 is a database that accumulates input orders in which a grammatical pattern of ladder programming is determined beforehand. Specifically, the pattern database 10 stores therein information of a command definitely described after a certain command. The pattern database 10 is created beforehand, and is provided in the command database unit 7.

The expert database 8, the personal database 9, and the pattern database 10 are provided in the command database unit 7 for each type of device to be programmed. For example, in FIG. 1, the command database unit 7 includes a database (DB) 7A for device A, a database (DB) 7B for device B, a database (DB) 7C for device C, and a database (DB) 7D for a device D. The databases 7A to 7D respectively include the expert database (DB) 8, the personal database (DB) 9, and the pattern database (DB) 10. The database to be accessed among the command database unit 7 for each device type is specified by the identification information stored in the set-value storage unit 1.

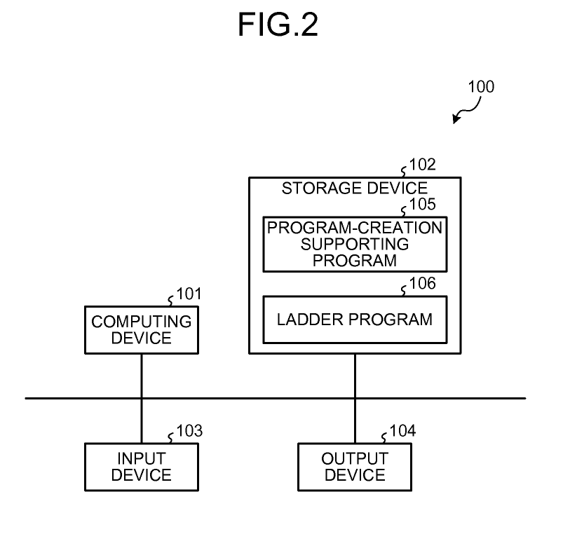

FIG. 2 shows a hardware configuration example of the program-creation supporting device 100 according to the embodiment of the present invention. As shown in FIG. 2, the program-creation supporting device 100 includes a computing device 101, a storage device 102, an input device 103, and an output device 104. The computing device 101, the storage device 102, the input device 103, and the output device 104 are connected to one another by busses.

The storage device 102 is constituted by a non-volatile memory, a volatile memory, an external storage device, or a combination thereof. The storage device 102 is a recording medium having a program-creation supporting program 105 recorded therein. The storage device 102 functions as an output destination of the ladder program 106 created by the program-creation supporting device 100.

The computing device 101 is, for example, a CPU (Central Processing Unit). The computing device 101 functions as the processing unit 3, the command-candidate output unit 4, and the display unit 6 by executing the program-creation supporting program 105 stored in the storage device 102. The set-value storage unit 1, the previous-command storage unit 2, the command-help database unit 5, and the command database unit 7 are realized by securing the corresponding areas respectively in the storage device 102.

The input device 103 is an input unit for receiving operations with respect to the program-creation supporting device 100 or inputs for creating the ladder program 106 stored in the storage device 102, and is constituted by, for example, a keyboard. The output device 104 is a display unit that displays output information with respect to a user based on an image frame generated by the display unit 6, and for example, is a liquid crystal display. The input device 103 and the output device 104 can be constituted by a touch panel device.

As a recording medium storing therein the program-creation supporting program 105 beforehand, an arbitrary medium can be adopted as long as it is a tangible medium, which is not temporary. For example, as the recording medium storing therein the program-creation supporting program 105 beforehand, a non-volatile memory, an external storage device, a detachable non-volatile memory, a CD-ROM, or a DVD-ROM can be adopted.

Operations of the program-creation supporting device 100 are explained next. To simplify explanations of the operations, it is assumed that the previous-command storage unit 2 stores therein only one command, and one first command is associated with each of the second commands and registered in the various databases (the expert database 8, the personal database 9, and the pattern database 10).

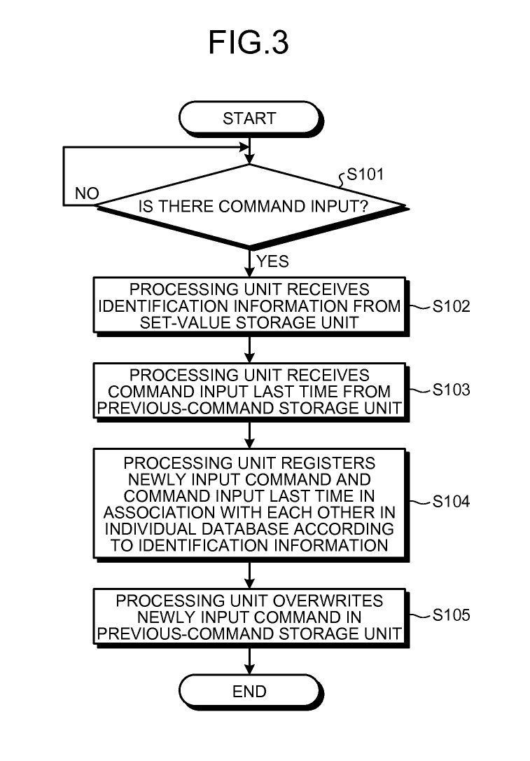

FIG. 3 is a flowchart for explaining the operation by which the program-creation supporting device 100 establishes the personal database 9. As shown in FIG. 3, the processing unit 3 waits for an input of a command from a user, and determines whether there is a command input (Step S101). If there is no command input (NO at Step S101), the processing unit 3 performs an operation in Step S101 again.

If there is a command input (YES at Step S101), the processing unit 3 receives identification information from the set-value storage unit 1 (Step S102), and receives a lastly input command from the previous-command storage unit 2 (Step S103). The processing unit 3 registers a newly input command in association with the command received in Step S103 in the personal database 9 (Step S104). When an entry same as an entry to be registered in the process at Step S104 has been already registered, the processing unit 3 increments the count value related to the already registered entry by 1, and does not execute registration of a new entry. When an entry same as an entry to be registered has not been registered, the processing unit 3 registers a new entry, and sets the count value related to the new entry to 1. The database to which the new entry is to be registered in the process in Step S104 is a personal database 9 that is included in the database related to the device type specified by the identification information received in Step S102 among the databases for respective device types constituting the database unit 7.

Subsequent to the process in Step S104, the processing unit 3 overwrites the storage content of the previous-command storage unit 2 by the newly input command (Step S105), to finish the operation.

FIG. 4 is an explanatory diagram of a registration example in to the personal database 9. In FIG. 4, an example in which a user creates the ladder program of the device A via an edit screen 200 displayed on the output device 104 is shown. Upon completion of an input of a command “LD X0” following the input of a command “OUT Y74” by the user, the processing unit 3 reads the previously input command “OUT Y74”, which has been stored in the previous-command storage unit 2, and registers “LD X0” and “OUT Y74” in the personal database 9 as one set. Specifically, the processing unit 3 registers “LD X0” as a newly input command (the second command), and “OUT Y74” as a previously input command (the first command) corresponding to “LD X0”. The processing unit 3 sets the count value of the registered entry to 1.

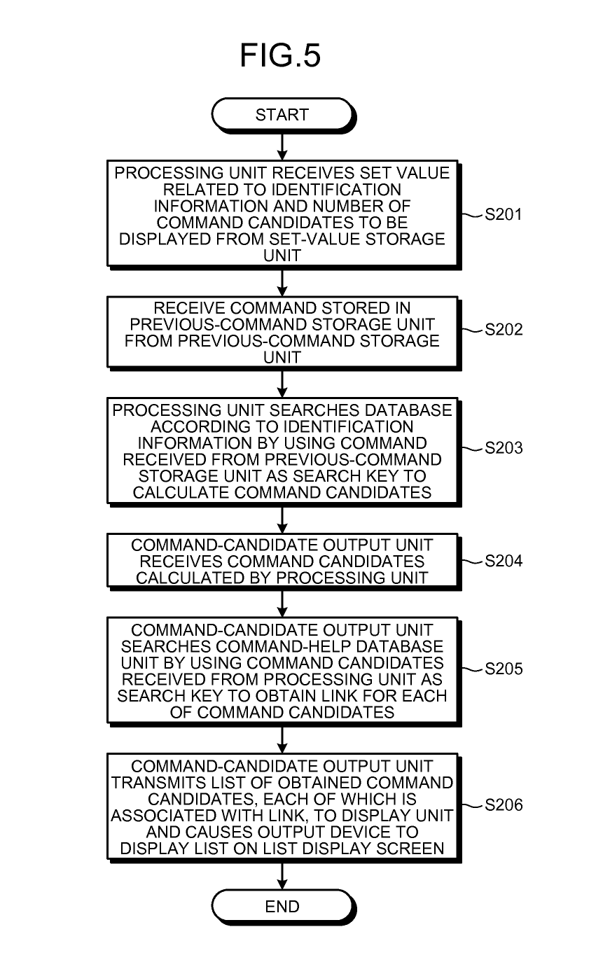

FIG. 5 is a flowchart for explaining the operation of the program-creation supporting device 100 in which the command candidates are calculated and displayed. The process of calculating and displaying the command candidates is performed, for example, in a state in which an input of a new command is waited for after the completion of an input of a command from a user. It is assumed here that the process in Step S105 is finished and the command, input of which is completed already, has been stored in the previous-command storage unit 2. It is also assumed here that the set value related to the calculation number of the command candidates has been set in the set-value storage unit 1 beforehand for each type of database.

As shown in FIG. 5, the processing unit 3 receives the set value related to identification information and the number of command candidates to be displayed from the set-value storage unit 1 (Step S201), and receives the command stored in the previous-command storage unit 2 from the previous-command storage unit 2 (Step S202).

Then, the processing unit 3 searches the databases 8 to 10 by using the command obtained by performing the process in Step S202 as a search key to calculate the command candidates (Step S203). Specifically, the processing unit 3 searches for an entry in which the command obtained by performing the process in Step S202 has been registered in the databases 8 to 10 as the first command. The processing unit 3 sets the command registered as the second command in the entry obtained by the search as a command candidate.

If the commands exceeding the set value have been obtained from the expert database 8, the processing unit 3 selects command candidates from the obtained commands by using an arbitrary method. The processing unit 3 performs the same process when the commands exceeding the set value have been obtained from the pattern database 10. When the commands exceeding the set value have been obtained from the personal database 9, the processing unit 3 selects command candidates by giving priority to a value having a larger count value.

The processing unit 3 sets, as a search target, the database related to the device type specified by the identification information obtained by performing the process in Step S102 among the databases for respective device types constituting the database unit 7.

Subsequently, the command-candidate output unit 4 receives the command candidates calculated by the processing unit 3 (Step S204). The command-candidate output unit 4 searches the command-help database unit 5 by using the received command candidates as a search key to obtain a link for each command candidate (Step S205). The command-candidate output unit 4 transmits a list of the obtained command candidates in association with the link and each command candidate to the display unit 6, and causes the output device 104 to display the list on the list display screen (Step S206) to finish the operation.

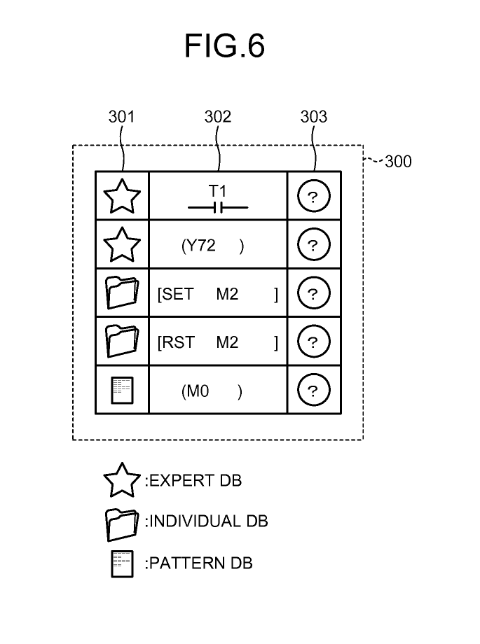

FIG. 6 shows an example of a list display screen. As shown in FIG. 6, a list display screen 300 includes a field 301 indicating the type of the database to be searched, a field 302 indicating the command candidates, and a field 303 indicating a link. Five command candidates are displayed here. It is indicated here that two command candidates of the five command candidates are searched from the expert database 8, other two command candidates are searched from the personal database 9, and the remaining one command candidate is searched from the pattern database 10. In order to display the searched database, for example, it suffices that the processing unit 3 transmits the extracted second command to the command-candidate output unit 4 together with information specifying the searched database.

A link button with which a link is associated inside is displayed in the field 303. When a user presses the corresponding link button by a mouse, a link corresponding to the pressed link button is read out. Then, help is read from the address indicated by the read-out link, and the read-out help is displayed on the display screen. When the user selects one from the five command candidates displayed on the list display screen 300, the processing unit 3 can receive the selected command as a new input.

The list display screen 300 can be displayed on the edit screen 200 so as to overlap on the edit screen 200, or can be displayed as a window different from the edit screen 200.

According to the embodiment of the present invention, the program-creation supporting device 100 is configured to store the first command and the second command following the first command in association with the each other in the command database unit 7, store a lastly input command from a user in the previous-command storage unit 2, search for the first command in the command database unit 7 by using the command stored in the previous-command storage unit 2 as a search key, in a state for waiting for an input of a new command from the user, to extract a second command corresponding to the command stored in the previous-command storage unit 2, and to display the extracted second commands in a list format on the display screen. Accordingly, the program-creation supporting device 100 can present the command candidates to the user without requiring an input of a part of character strings constituting the command. Furthermore, the command to be input next is estimated based on the last command, the input of which has been finished by the user, and is displayed to the user. Accordingly, an accurate command candidate can be presented to the user as compared with a method of presenting the candidates simply based on the number of inputs without taking into consideration whether it is the latest input. That is, according to the embodiment of the present invention, command input can be efficiently supported.

The program-creation supporting device 100 further includes the personal database 9 in which the entries are added sequentially based on an input history of the user. Therefore, a command already used by the user is presented automatically, thereby enabling to reduce time and effort for searching and shorten the time for programming.

Because the program-creation supporting device 100 further includes an expert database 8 created beforehand based on an input history of a predetermined user (an expert), even a beginner for programming can easily use a command used by the expert as a reference, to create a program having higher quality.

The program-creation supporting device 100 further includes a pattern database 10 created beforehand based on a grammatical pattern, thereby enabling to prevent a user from forgetting to describe the command, the grammatical pattern of which is determined beforehand.

The program-creation supporting device 100 can cause the user to select a command candidate from various options by presenting the command candidates to the user from each of the three databases of the expert database 8, the personal database 9, and the pattern database 10, respectively, and thus a program having high quality can be created depending on a situation.

The program-creation supporting device 100 is configured such that the user can set the number of command candidates to be calculated and displayed, respectively, regarding the expert database 8, the personal database 9, and the pattern database 10 in the set-value storage unit 1. Therefore, for a beginner, many command candidates can be presented from the expert database 8 such that the beginner can check what kind of commands the expert uses. The expert feels troublesome if a command described by others is presented, and thus it can be set such that no command candidate is presented from the expert database 8 to the expert. That is, the command candidates according to each user can be presented.

The program-creation supporting device 100 records the number of use in the personal database 9 for each entry. If the number of extracted second commands exceeds the number of a set upper limit, the program-creation supporting device 100 sets a command related to the entry having a higher use frequency as a command candidate preferentially. Because the program-creation supporting device 100 automatically presents commands described by the user frequently, the user can perform programming efficiently.

The program-creation supporting device 100 further includes database for each type of device to be programmed. Accordingly, even if a device to be programmed is changed, the command candidate corresponding to the control of the device can be selected with less trouble, thereby enabling to reduce the man-hours for programming.

The program-creation supporting device 100 displays the command candidates in a list format in association with a help for each command candidate. Accordingly, the user can refer to the help for each command candidate.

### INDUSTRIAL APPLICABILITY

As described above, the program-creation supporting device, the program-creation supporting method, and the recording medium according to the present invention are preferably applicable to a program-creation supporting device that supports creation of a program for operating a PLC, a program-creation supporting method, and a recording medium having a program recorded therein.

### REFERENCE SIGNS LIST

1 set-value storage unit, 2 previous-command storage unit, 3 processing unit, 4 command-candidate output unit, 5 command-help database unit, 6 display unit, command database unit, 7A to 7D database, 8 expert database, 9 personal database, 10 pattern database, 100 program-creation supporting device, 101 computing device, 102 storage device, 103 input device, 104 output device, 105 program-creation supporting program, 106 ladder program, 200 edit screen, 300 list display screen, 301, 302, 303 field.

1.-9. (canceled)

10. A program-creation supporting device that creates a program for operating a programmable logic controller (PLC) based on commands sequentially input to the PLC from a user, the program-creation supporting device comprising:
a command database unit that is a database for storing a first command and a second command that follows the first command in association with each other;
a command storage unit that stores therein a last command input from the user;
a processing unit that searches for the first command in the command database unit by using a command stored in the command storage unit as a search key, in a waiting state for waiting an input of a new command from the user, without requiring an input of a part of the new command and extracts a second command corresponding to the command stored in the command storage unit; and
an output unit that displays the second commands extracted by the processing unit in a list format on a display screen, wherein
the command database unit includes a first database created beforehand based on an input history of a predetermined user, or created beforehand based on a grammatical pattern.

11. The program-creation supporting device according to claim 10, wherein
the command database unit further includes a second database, and
upon reception of input of a new command from a user, the processing unit registers the command stored in the command storage unit and the input new command in the second database, designating the command stored in the command storage unit as a first command and the input new command as a second command, before updating the stored content of the command storage unit.

12. The program-creation supporting device according to claim 10, further comprising a set-value storage unit that stores therein beforehand a set value that defines an upper limit of number of commands to be displayed for each database, wherein
the processing unit extracts a second command corresponding to the command stored in the command storage unit for the number defined by the set value as an upper limit.

13. The program-creation supporting device according to claim 11, further comprising a set-value storage unit that stores therein beforehand a set value that defines an upper limit of number of commands to be displayed, wherein
the processing unit records the number of use of each pair of a first command and a second command in the second database, and extracts a second command corresponding to the command stored in the command storage unit for the number defined by the set value as an upper limit, and by giving priority to a pair having a higher number of use.

14. The program-creation supporting device according to claim 13, comprising the command database unit for each type of device to be programmed, and
further comprising an identification-information storage unit that stores therein identification information that specifies a PLC, wherein
the processing unit specifies the command database unit to be accessed among a plurality of the command database units, by using the identification information stored in the identification-information storage unit.

15. The program-creation supporting device according to claim 10, wherein the output unit displays help for each of the second commands extracted by the processing unit in a list format in association with each other.

16. A method of creating a program that operates a programmable logic controller (PLC), which is executed by a computer, the method comprising:
storing a last command input from the user in a command storage unit;
searching for a first command in a database in which a first command and a second command that follows the first command are associated with each other, which is created beforehand based on an input history of a predetermined user or created beforehand based on a grammatical pattern, by using a command stored in the command storage unit as a search key, in a waiting state for waiting for an input of a new command from the user without requiring input of a part of the new command, to extract a second command corresponding to the last command input from the user;
displaying the extracted second commands in a list format on a display screen; and
creating the program based on the commands sequentially input from the user.

17. A recording medium having recorded therein a program for creating a program that operates a programmable logic controller (PLC), wherein
the program causes a computer to execute:
storing a last command input from the user in a command storage unit;
searching for a first command in a database in which a first command and a second command that follows the first command are associated with each other, which is created beforehand based on an input history of a predetermined user or created beforehand based on a grammatical pattern, by using a command stored in the command storage unit as a search key, in a waiting state for waiting for an input of a new command from the user without requiring input of a part of the new command, to extract a second command corresponding to the last command input from the user;
displaying the extracted second commands in a list format on a display screen; and
creating the program based on the commands sequentially input from the user.
